(19) United States
(12) Patent Application Publication
(10) Pub. No.: US 2026/0087224 A1
(43) Pub. Date: Mar. 26, 2026

(54) SIGNOFF-ACCURATE VLSI GATE SIZING FOR SIMULTANEOUS TIMING AND POWER OPTIMIZATION USING LARGE LANGUAGE MODELS

(71) Applicant: NVIDIA Corporation, Santa Clara, CA (US)

(72) Inventors: Haoxing Ren, Austin, TX (US); Yi-Chen Lu, Tucker, GA (US)

(21) Appl. No.: 19/039,545

(22) Filed: Jan. 28, 2025

Related U.S. Application Data
(60) Provisional application No. 63/697,877, filed on Sep. 23, 2024.
(60) Provisional application No. 63/697,998, filed on Sep. 23, 2024.
(60) Provisional application No. 63/712,477, filed on Oct. 27, 2024.

(51) Int. Cl. G06F 30/392; G06F 117/12; G06F 119/06

(52) U.S. Cl. CPC G06F 30/392; G06F 2117/12; G06F 2119/06

(57) ABSTRACT

Systems and methods are disclosed that perform very large scale integration (VLSI) gate sizing for power, performance, and area (PPA) optimization. For example, initial data structures associated with a circuit pathway indicating a pathway for a signal to propagate from a start point, through a plurality of hardware gates, to an end point may be obtained. A plurality of input strings for the plurality of hardware gates may be generated using the initial data structures. A first embedding generator may be used to generate first embeddings for the plurality of input strings. Output strings for the plurality of hardware gates may be generated based on processing the first embeddings associated with the plurality of input strings using a large language model (LLM). The output strings indicate optimized library cells (LibCells) for the plurality of hardware gates from a LibCell database.

### CLAIM OF PRIORITY

This application claims the benefit of U.S. Provisional Application No. 63/697,877 (Attorney Docket No. 515053) titled “Signoff-Accurate VLSI Gate Sizing for Simultaneous Timing and Power Optimization using Large Language Models,” filed Sep. 23, 2024, U.S. Provisional Application No. 63/697,998 (Attorney Docket No. 515055) titled “Signoff-Accurate VLSI Gate Sizing for Simultaneous Timing and Power Optimization using Large Language Models,” filed Sep. 23, 2024, and U.S. Provisional Application No. 63/712,477 (Attorney Docket No. 515126) titled “Signoff-Accurate VLSI Gate Sizing for Simultaneous Timing and Power Optimization using Large Language Models,” filed Oct. 27, 2024, the entire contents of which are incorporated herein by reference.

### BACKGROUND

Gate sizing is a fundamental optimization step in Physical Design (PD) that is used extensively from synthesis to signoff to improve Power, Performance, and Area (PPA) metrics. However, in advanced technologies (e.g., 5 nanometers (nm) and below), achieving desirable gate sizing results have become an increasingly challenging task. For instance, conventional approaches rely on multiple sizing iterations to meet PPA targets, which demand vast computational resources and extended runtime as modern designs easily include millions of instances. Furthermore, the relentless pursuit of high-performance and low-power designs forces signoff tools to adopt Path-Based Analysis (PBA) for timing verification to counter the pessimism of Graph-Based Analysis (GBA) and minimize over-design, which aggravates the runtime burden. Hence, the desire for more efficient, scalable, and generalizable gate sizing methods has become extremely urgent.

Recently, analytical algorithms and learning-based techniques such as Machine Learning (ML) techniques have emerged as a promising solution to improve the gate sizing process. For instance, many current ML approaches focus on building supervised prediction models aimed at boosting design productivity by enabling rapid sizing predictions. However, such approaches lack the ability to generalize to new designs (e.g., designs unseen during training). Therefore, such approaches fail to reach optimal PPA optimization results and cannot achieve signoff quality. As such, there is a need for addressing these issues and/or other issues associated with the prior art.

### SUMMARY

Embodiments of the present disclosure relate to signoff-accurate very large scale integration (VLSI) gate sizing for simultaneous timing and power optimization using large language models (LLMs). For example, systems and methods are disclosed that utilize a generative framework that includes LLMs and graphics processing unit (GPU)-accelerated differentiable techniques to enable more efficient, scalable, and generalization gate sizing method.

For instance, many conventional approaches, such as conventional ML approaches, have focused on building supervised prediction models aimed at boosting design productivity by enabling rapid sizing predictions. However, these conventional methods fail to generalize across unseen designs and are fundamentally constrained by the training dataset, making them impossible to outperform the tools they aim to emulate. In contrast to conventional systems, such as those described above, embodiments of the present disclosure utilize an LLM-Enhanced GPU-Optimized signoff-accurate differentiable VLSI gate sizing in advanced nodes (LEGO-Size) system and method that leverages LLMs and GPU-accelerated differentiable approaches for gate sizing prediction and/or optimization. By utilizing LEGO-Size, embodiments of the present disclosure may provide a scalable, generalizable framework that is capable of delivering instant, better-than-tool signoff timing optimization results on unseen designs in advanced nodes. For instance, embodiments of the present disclosure describe a generative framework that harnesses the power of LLMs and GPU-accelerated differentiable techniques to achieve better-than-tool gate sizing results in signoff-quality. As will be described in further detail below, the LEGO-Size system and method introduces multiple aspects. For instance, the LEGO-Size system and method considers timing paths as sequences of tokenized library cells (e.g., strings), which casts the gate sizing prediction task as a language modeling problem and solves the problem through customized self-supervised learning and Supervised FineTuning (SFT) approaches. The LEGO-Size system and method develops a Graph Transformer (GT) with a linear-complexity attention mechanism for netlist encoding, which enables the LLMs to make sizing decisions with a global perspective.

In an embodiment, a computer-implemented method for performing very large scale integration (VLSI) gate sizing for power, performance, and area (PPA) optimization is provided. The method comprises obtaining initial data structures associated with a circuit pathway indicating a pathway for a signal to propagate from a start point, through a plurality of hardware gates, to an end point and generating a plurality of input strings for the plurality of hardware gates using the initial data structures. The method further comprises using a first embedding generator to generate first embeddings for the plurality of input strings and generating output strings for the plurality of hardware gates based on processing the first embeddings associated with the plurality of input strings using a large language model (LLM). The output strings indicate optimized library cells (LibCells) for the plurality of hardware gates from a LibCell database.

### BRIEF DESCRIPTION OF THE DRAWINGS

The present systems and methods for sign-off accurate VLSI gate sizing for simultaneous timing and power optimization using LLMs are described in detail below with reference to the attached drawing figures, wherein:

FIG. 1A illustrates an exemplary LEGO-Size overview that includes a LEGO-Size model (e.g., an LLM-Enhanced GPU-Optimized (LEGO) model) having LEGO-Size embedding generators and a LEGO-Size LLM, in accordance with an embodiment;

FIG. 1B shows an exemplary circuit pathway that may be optimized by the LEGO-Size model, in accordance with an embodiment;

FIG. 1C shows an exemplary circuit with a circuit pathway that may be optimized by the LEGO-Size model, in accordance with an embodiment;

FIG. 2 shows a block diagram for performing the LEGO-Size process, in accordance with an embodiment;

FIG. 3 provides a flow diagram illustrating a method for performing VLSI gate sizing for PPA optimization using the LEGO-Size model, in accordance with an embodiment;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary game streaming system suitable for use in implementing some embodiments of the present disclosure.

### DETAILED DESCRIPTION

Systems and methods are disclosed herein that relate to sign-off accurate VLSI gate sizing for simultaneous timing and power optimization using LLMs, and in particular to using a LEGO-Size model for performing VLSI gate sizing for PPA optimization. For instance, On-Chip Variation (OCV)-aware, PBA-accurate timing optimization is a critical step in signoff optimization. However, in advanced nodes, conventional tools often yield sub-optimal sizing results due to the intricate design characteristics and the vast number of choices of library cells, which requires significant runtime and computational resources for thorough exploration. To overcome these issues, embodiments of the present disclosure utilize a LEGO-Size model that includes LEGO-Size embedding generators and a LEGO-Size LLM for performing VLSI gate sizing for PPA optimization.

For example, by using a LEGO-size model, embodiments of the present disclosure relate to a scalable, generalizable framework that is capable of delivering instant, better-than-tool signoff timing optimization results on unseen designs in advanced nodes. The LEGO-size model may be a generative framework that leverages the power of LLMs and GPU-accelerated differentiable techniques for gate sizing prediction and optimization. During testing, the LEGO-size model was shown to outperform an industry-leading signoff tool, at a commercial 3 nm node with more than 10,000 library cells across five unseen industrial designs, each with millions of cells. For instance, experimental results on these five industrial designs demonstrate that the LEGO-Size achieves up to a 125 times speed up with 37% TNS improvement over this industry-leading commercial signoff tool with minimal power overhead.

As will be described in further detail below, embodiments of the present disclosure cast the gate sizing prediction problem as a language modeling task such as by developing the concept of library cell tokens for exact gate sizing prediction. Additionally, and/or alternatively, whereas previous gate sizing prediction methods are all confined to supervised learning setting, embodiments of the present disclosure introduce self-supervised learning tasks, including masked token prediction and arrival time increment prediction, which enhances the generalizability of the LEGO-size model. Additionally, and/or alternatively, embodiments of the present disclosure describe a signoff-accurate differentiable gate sizing framework in PD, which refines gate size probabilities through gradient descent. Unlike conventionally approaches, embodiments of the present disclosure are deterministic, OCV aware, and signoff-accurate. As such, embodiments of the present disclosure achieve a 0.99 endpoint slack correlation with a commercial signoff tool in OCV-mode.

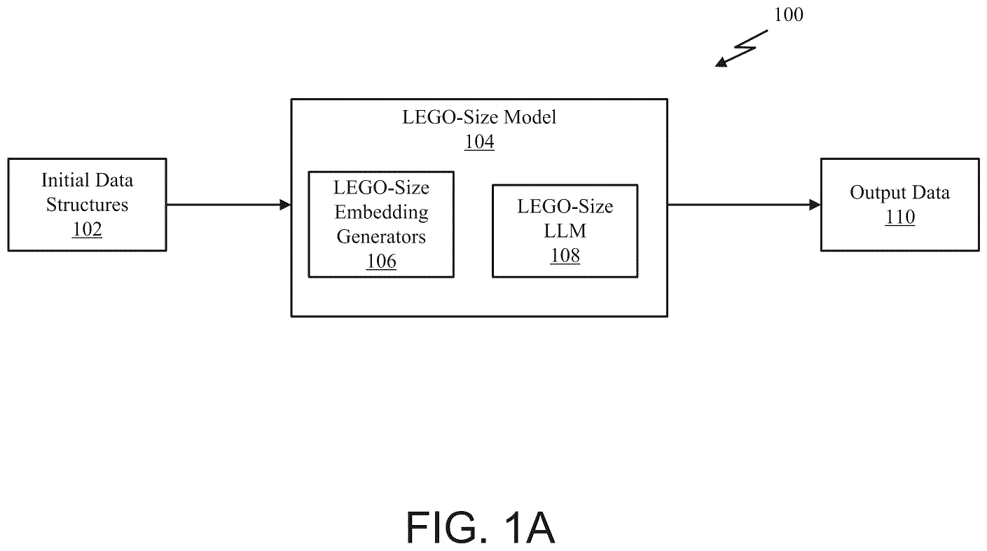

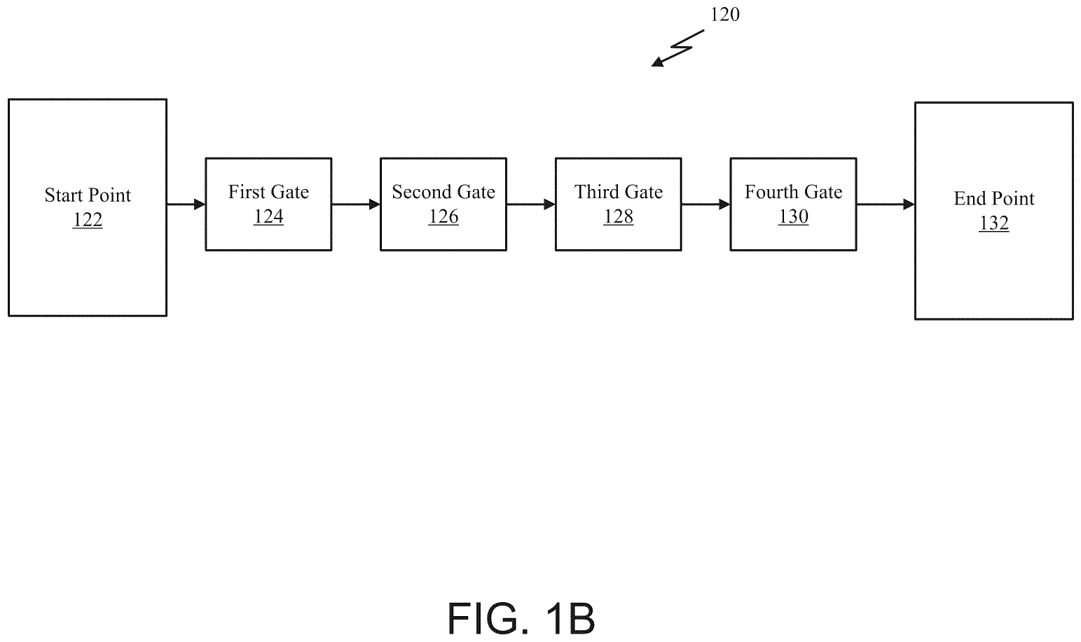

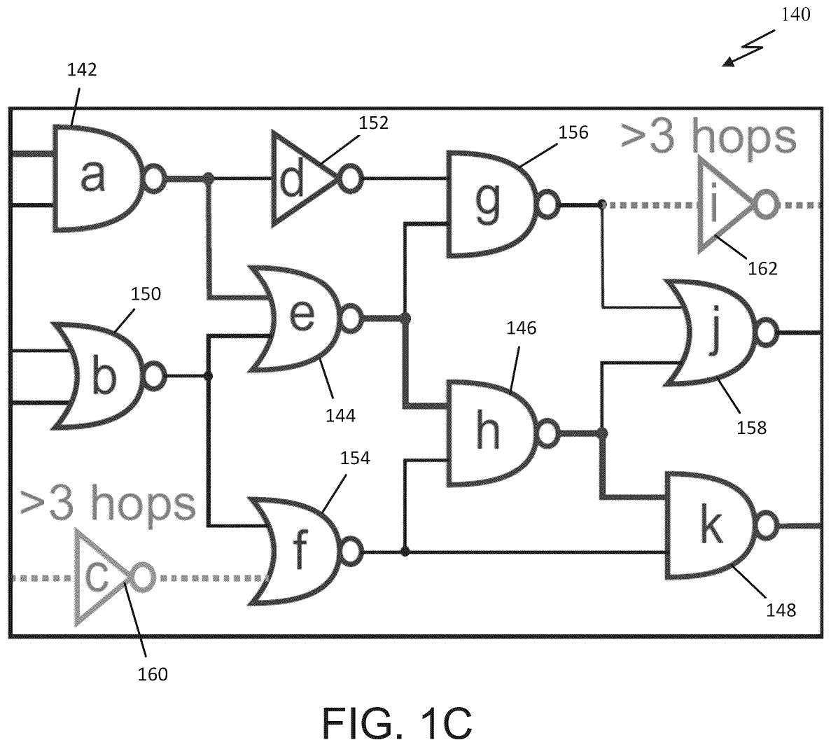

FIG. 1A illustrates an exemplary LEGO-Size overview 100 that includes a LEGO-Size model 104 (e.g., an LLM-Enhanced GPU-Optimized (LEGO) model) having LEGO-Size embedding generators 106 and a LEGO-Size LLM 108, in accordance with an embodiment. For instance, the LEGO-Size model 104 may obtain initial data structures 102 as input and may generate output data 110. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the LEGO-Size model 104 is within the scope and spirit of embodiments of the present disclosure.

For example, the LEGO-Size model 104 may be configured to optimize VLSI gate sizing for PPA optimization such as by optimizing hardware circuitry (e.g., a circuit pathway such as the circuit pathway shown in FIG. 1B) along given paths. FIG. 1B shows an exemplary circuit pathway 120 that may be optimized by the LEGO-Size model 104, in accordance with an embodiment. As shown, the circuit pathway 120 includes a start point 122, four gates 124-130 (e.g., four cells and/or nodes), and an end point 132. The four gates 124-130 are merely exemplary and the LEGO-Size model 104 may be able to optimize any circuit pathway including circuit pathways with any number of gates (e.g., two gates, five gates, ten gates, and so on). The start point 122 and the end point 132 may be any component, entity, hardware, and/or aspect that denote a start point and an end point for the circuit pathway 120. For instance, the start point 122 may be a circuit component such as a first D-flip flop and the end point 132 may be another circuit component such as a second D-flip flop. The gates 124-130 may be any type of logic gate, circuitry, nodes, and/or cells such as, but not limited to, AND gates, OR gates, XOR gates, Buffers, inverters, delay circuits, and/or other types of logic gates and/or circuitry. For example, the gate 124 may be a buffer, the gate 126 may be an AND gate, the gate 128 may be an OR gate, and the gate 130 may be a delay circuitry. Furthermore, only the gates 124-130 from the circuit pathway 120 is shown in FIG. 1B, but as known, certain logic gates such as AND gates and OR gates, may include multiple inputs. For instance, the gate 126 may include a first input that is from the circuit pathway 120 (e.g., from the first gate 124) and one or more second inputs that are from other circuit elements that are not shown in FIG. 1B (e.g., from an inverter). As such, the circuit pathway 120 may be associated with a larger circuit for a processor/chip/integrated circuit (IC).

FIG. 1C shows an exemplary circuit 140 with a circuit pathway that may be optimized by the LEGO-Size model, in accordance with an embodiment. For example, the circuit 140 includes gates 142-148 of the circuit pathway, which may be the gates 124-130 of the circuit pathway 120 shown in FIG. 1B. Furthermore, the circuit 140 may include 150-158, which may be support cells or gates (e.g., gates that include an output that connects to an input of a gate from the circuit pathway). In addition, additional gates such as 160-162 may be greater than three hops away from the gates of the circuit pathway and thus might not be critical.

Returning back to FIG. 1A, the LEGO-Size model 104 may be utilized to optimize circuit pathways such as circuit pathway 120. For example, the initial data structures 102 may include characteristic information (e.g., features) associated with the circuit pathway such as the gates (e.g., the gates 124-130 of the circuit pathway 120 of FIG. 1B). For instance, the LEGO-Size model 104 may obtain an initial data structure 102 for each gate from the circuit pathway (e.g., obtain four initial data structures 102 for the four gates 124-130 from the circuit pathway 120). As such, the LEGO-Size model 104 may obtain initial data structures indicating a set of features for each of the gates from the circuit pathway. Further, in some examples, the LEGO-Size model 104 may obtain additional initial data structures for additional gates that neighbor the gates from the circuit pathway (e.g., initial data structures for the additional gates 150-158 from the circuit 140 of FIG. 1C). For instance, the additional initial data structures may be associated with the larger circuit for the processor/chip/IC.

In some embodiments, the initial data structures may include physical features (e.g., cell density, congestion, and bounding box) and netlist features (e.g., input slew, output slew, output slack, input slack, output arrival, input arrival, total input capacitance, average fan-in capacitance, total pin resistance, average pin resistance, and/or total driving load). The initial data structures may indicate the feature, the number of dimensions, and a description of the features. For instance, the cell density may indicate the densities in 3×3, 5×5, and 7×7 bin granularities. The congestion may indicate the horizontal and vertical routing congestions. The bounding box may indicate the lower-left and upper-right coordinates. The input and output slews may indicate the maximum input transition of input pin(s) and the maximum transition of the output pin(s). The input and output slack may indicate the minimum setup slack of the output and input pin(s). The output and input arrival may indicate the maximum arrival of the input and output pin(s). The total input capacitance may indicate the sum of the input pin capacitance. The average fan-in capacitance may indicate the average capacitance of the fan-ins. The total pin resistance may indicate the sum of the library pin resistance. The average pin resistance may indicate the average library pin resistance. The total driving load may indicate the sum of the driving load capacitance.

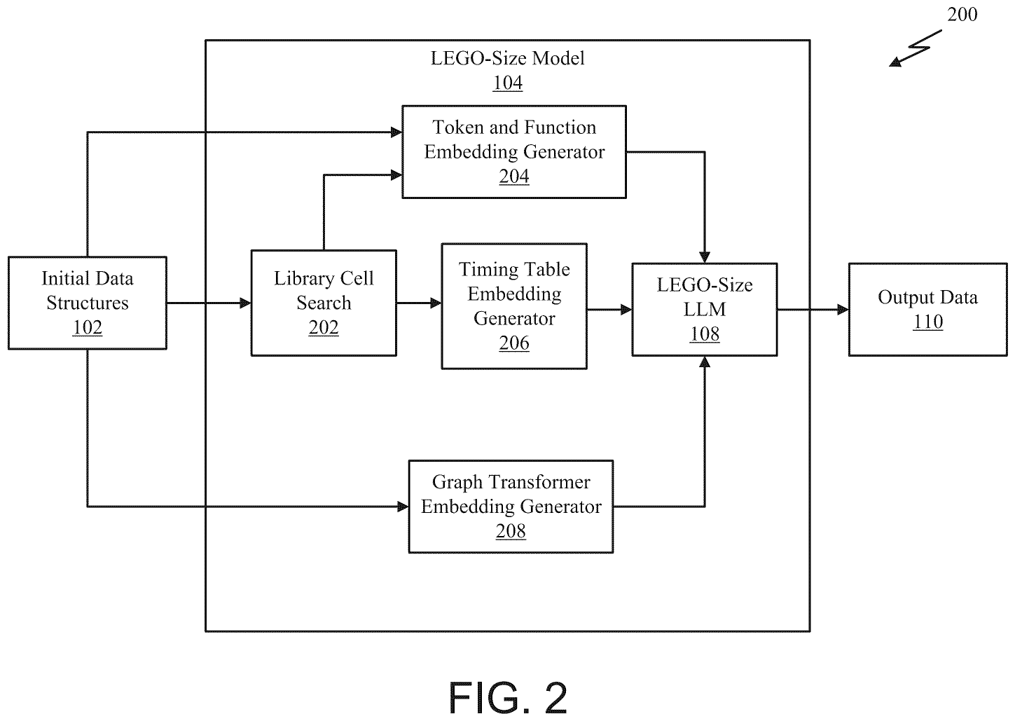

In other words, for the circuit design of the circuit pathway, a number of different gates including the same type of gate (e.g., an AND gate) with different gate characteristics (e.g., drive strength and/or threshold voltage (VT)) may be utilized to design the circuit pathway. To perform VLSI gate sizing for PPA, the LEGO-Size model 104 may use the initial data structures 102 to determine (e.g., select) the optimized gate, including gate characteristics, for each of the gates within the circuit pathway. For example, the LEGO-Size model 104 may process the initial data structures 102 using the LEGO-Size embedding generators 106 and the LEGO-Size LLM 108 to generate output data 110. The output data 110 may be, include, and/or indicate a text string that indicates the particular type of gate to be used within the circuit pathway. An overview of the LEGO-Size model 104 will be first described and then the process for using the LEGO-Size model 104 will be described subsequently in FIG. 2A.

For instance, the LEGO-Size model 104 provides an LLM-enhanced, PBA-accurate path-based prediction model. For example, given the necessity of PBA-accurate analysis to overcome GBA pessimism, gate sizing for timing optimization at signoff Engineering Change Order (ECO) stage is typically conducted on a path-by-path basis. Hence, the LEGO-Size model 104 may perform path-based gate sizing predictions to facilitate signoff fixing. Nonetheless, to ensure a global perspective in path-based predictions, a graph transformer (GT) model (e.g., a GT embedding generator 208) with a linear-complexity attention mechanism may be developed to encode global netlist features across the entire graph.

In some embodiments, the LEGO-Size model 104 may consider the timing paths as sequences of tokenized library cells (e.g., string-based tokens), and the gate sizing prediction task may be cast as a language modeling problem solved by LLMs. For instance, each library cell is tokenized into exactly three tokens denoting gate type, driving strength, and threshold voltage type (Vₜₕ). The embodiments of the present disclosure may different from a particular conventional approach given that the conventional approach lacks the concept of tokenization and only relies on handcrafted features to represent each cell. Thus, while the conventional approach may adopt a transformer-based architecture, the conventional approach is not a language-based model whereas the LEGO-Size model 104 is a language-based model.

Furthermore, the LEGO-Size model 104 introduces a PD-customized encoder only transformer model that predicts gate sizes for all cells on a path simultaneously. In addition, supervised pretraining tasks may be developed, including masked token prediction and arrival time increment (e.g., stage delay) prediction to warm up trainable parameters within the LEGO-Size model 104. These pre-training tasks may be crucial for enhancing the LEGO-Size model 104 generalizability and are shown to significantly accelerate training convergence in subsequent Supervised Fine-Tuning (SFT) tasks, such as path-based slack improvement prediction and final gate size prediction. For instance, while the SFT tasks use the tool's PBA-based signoff sizing results as labels, the self-supervised tasks require no optimization labels. That is, both features and labels for the self-supervised pre-training tasks are generated from the design state before running the signoff optimization. This may greatly mitigate the data scarcity challenge in the realm of PD, because such pre-optimized databases are abundant in any semiconductor company.

FIG. 2A shows a block diagram 200 for performing the LEGO-Size process, in accordance with an embodiment. One or more blocks 200 of the LEGO-Size process, described herein, may comprise a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. In addition, the process is described, by way of example, with respect to the system of FIG. 1A. However, this process may additionally or alternatively be executed by any one system, or any combination of systems, including, but not limited to, those described herein. Furthermore, persons of ordinary skill in the art will understand that any system that performs the process described in FIG. 2A is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

As shown, the LEGO-Size model 104 includes a library cell search 202, three embedding generators 106 that generate embeddings (e.g., a token and function embedding generator 204, a timing table embedding generator 206, and a graph transformer embedding generator 208), and a LEGO-Size LLM 108. For each gate (e.g., gate 126 from FIG. 1B), the LEGO-Size model 104 may generate three embeddings (e.g., a token and function embedding, a timing table embedding, and a graph transformer embedding) and concatenate the embeddings into a concatenated embedding. Then, the LEGO-Size model 104 may process the concatenated embeddings for each gate (e.g., the four concatenated embeddings for the gates 124-130) using the LEGO-Size LLM 108 to generate an LLM output indicating a text-string associated with the optimized gates for the circuit pathway. This will be described in further detail below.

To generate the embeddings, the LEGO-Size model 104 may utilize a library such as a library cell (LibCell) library (e.g., a LibCell database). For instance, each potential gate to be used within a circuit pathway may be associated with a LibCell that indicates a logic function and/or gate (e.g., an AND gate, an OR gate, or a Buffer). For example, the LibCell may indicate a gate type (e.g., whether the gate is an AND gate or an OR gate). Furthermore, the LibCell may also indicate a driving strength, a threshold voltage (VT), and/or other gate characteristic information. For instance, in some embodiments, the LibCell library may include thousands or tens of thousands of LibCell entries. For example, for a particular gate type (e.g., AND gate), the LibCell library may include a plurality of entries associated with different driving strengths and/or VTs.

After receiving the initial data structures 102, the LEGO-Size model 104 may utilize the library cell search 202 to determine and/or generate strings (e.g., input strings) associated with the initial data structures 102. For example, referring back to FIG. 1B, the circuit pathway 120 includes four gates 124-130. The LEGO-Size model 104 may process the initial data structure 102 for the first gate 124 using the library cell search 202 to determine a first string associated with the first gate 124. For instance, the library cell search 202 may search the LibCell library for a LibCell entry that matches the features indicated by the initial data structure 102 for the first gate 124, and retrieve information associated with the appropriate LibCell entry such as a gate type, a drive strength, and a VT. Then, the library cell search 202 may generate a string associated with the LibCell entry and the string may indicate three elements (e.g., the gate type, the drive strength, and the VT) associated with the retrieved information from the LibCell library. For example, the library cell search 202 may retrieve information indicating the first gate 124 is a Buffer, has a drive strength of four, and a low VT. Thus, the library cell search 202 may generate the string “BUFXD4LVT” where “BUFX” indicates that the gate type is a Buffer, “D4” indicates the drive strength is four, and “LVT” indicating a low VT. Subsequently, the LEGO-Size model 104 may process the initial data structures 102 for the second through fourth gates 126-130 to generate second, third, and fourth strings associated with the gates 126-130.

In some examples, the input strings (as well as the output strings described below) may be the LibCell names, which may be formed by a type token (e.g., “BUF”), a drive strength token (e.g., “D3”), and a threshold-voltage token (e.g., “LVT”). In other words, these three tokens may form the string (e.g., “BUFD3LVT”), which denotes the LibCell name.

In some variations, each gate (e.g., the four gates 124-130) in a netlist may be “implemented” by a LibCell. As such, the library cell search 202 may easily retrieve the LibCell name associated with each gate since the LibCell name generally follows the naming convention of the input strings (e.g., “BUFXD4LVT”, which indicates information of gate type, drive strength, and VT). In some instances, if this information is unable to be found, which may occur in special cases, then the library cell search 202 may perform a search through the library to determine the proper information.

The generated strings may be provided to the token and function embedding generator 204, and the token and function embedding generator 204 may generate embeddings (e.g., a token embedding and a function embedding) based on the strings from the library cell search 202. For example, the token and function embedding generator 204 may include and/or utilize one or more trainable library embeddings tables such as a trainable library token embedding table and a trainable function embedding table. The library token embedding table may be a table or an array (e.g., a two-dimensional (2D) array) that includes a plurality of rows of embeddings. Each row may be associated with a particular element of a string. For example, as mentioned above, each string may include three elements (e.g., the gate type, the drive strength, and the VT) such as “BUFXD4LVT” for the first string for the first gate 124. The token and function embedding generator 204 may perform a look-up using the three elements of the string to determine embeddings for each of the elements. For instance, a particular row of the library token embedding table may indicate a token for “BUFX”, another row of the library token embedding table may indicate a token for “D4”, and yet another row of the library token embedding table may indicate a token for “LVT.” As such, using the library token embedding table, the token and function embedding generator 204 may obtain three tokens for the string from the library cell search 202.

Similarly, using the trainable function embedding table (e.g., a trainable function embedding array), the token and function embedding generator 204 may generate a function embedding. For instance, using the initial data structures 102, the token and function embedding generator 204 may determine a function identifier for each of the gates of the circuit pathway (e.g., a function identifier for each of the four gates 124-130 from the circuit pathway 120). For example, the function identifier may be determined in any library and each LibCell may be associated with exactly one function identifier. In some examples, different LibCells may also belong to the same function identifier.

After generating the function embedding and the three tokens for the gates from the circuit pathway, the token and function embedding generator 204 may provide a token and function embedding to the LEGO-Size LLM 108. For instance, the token and function embedding generator 204 may combine (e.g., concatenate) the three tokens and the function embedding into a LibCell name embedding for the gate. The token and function embedding generator 204 may do this for each of the gates, and then provide the LibCell name embeddings to the LEGO-Size LLM 108. For instance, referring to FIG. 1B, the token and function embedding generator 204 may generate four LibCell name embeddings for the gates 124-130 of the circuit pathway 120, and provide the generated LibCell name embeddings to the LEGO-Size LLM 108.

In other words, in PD, conventional efforts have primarily focused on enhancing productivity through human-machine interaction (e.g., prompting) using natural language. However, conventional efforts have not demonstrated the use of LLMs to solve combinatorial nature tasks such as gate sizing. As such, embodiments of the present disclosure describe an LLM-based framework that solves the gate sizing task via language modeling.

As aforementioned, embodiments of the present disclosure consider a timing path as a sequence of tokenized library cells. For example, a library cell name may be tokenized into three tokens, denoting gate type, drive strength, and Vₜₕ type of the cell. Among other advantages, a particular advantage of tokenization is that it significantly reduces the number of tokens that are required to characterize the entire vocabulary. For example, although a commercial 3 nm node may include over 10,000 library cells, they may be formed by 300 tokens based on utilizing embodiments of the present disclosure. The This is shown by the following equation:

$$\# all libCells = \{ type tokens \} ⊗ \{ drv tokens \} ⊗ \{ {V}_{th} tokens \} ,$$

where {·} denotes a token set, ⊗ denotes the Cartesian product, meaning each element from one set is combined with every element from the other sets, # all libCells indicates the number of all of the LibCells in the LibCell library, and the gate type tokens, the drive (drv) strength tokens, and the Vₜₕ tokens are described above.

The sum of tokens across the three sets in the above equation is much smaller than the total number of combinations generated by the Cartesian product. Further, beside the library cell name tokenization, embodiments of the present disclosure may create a “function token” per library cell group denoting the functionality.

In addition, while token and function embeddings capture some characteristics of a library cell, they may fail to represent crucial physical properties such as timing tables, pin capacitance, and resistance, which are essential for accurate gate sizing. To address this, embodiments of the present disclosure introduce a convolutional neural network (CNN)-based timing table encoder (e.g., the timing table embedding generator 206) to encode cell delay and transition tables. The resulting table embeddings, along with pin capacitance and resistance, are concatenated with name embeddings to form the final cell embedding for the relevant arc in the timing path.

For example, in addition to the generated LibCell name embeddings, two other embeddings that are generated using the timing table embedding generator 206 and the graph transformer embedding generator 208 may also be provided to the LEGO-Size LLM 108. For instance, while token and function embeddings (e.g., the LibCell name embeddings) capture some characteristics of a LibCell, they fail to represent crucial physical properties such as timing tables, pin capacitance, and/or resistance, which may be essential for accurate gate sizing. As such, in addition to retrieving the gate type, the drive strength, and the VT for a LibCell, the library cell search 202 may further retrieve timing tables associated with the LibCell and the gate. For instance, the timing tables may be associated with a rise delay, a fall delay, a rise transition, and/or a fall transition of the LibCell. Each of the timing tables may be a 2D array with entries indicating timings for the LibCell. The library cell search 202 may provide the timing tables to the timing table embedding generator 206.

The timing table embedding generator 206 may process the timing tables such as by treating the timing tables similar to an image. For instance, an image may also be represented by a 2D array (e.g., height and width) and a plurality of channels (e.g., the three channels for the red, green, blue (RGB) representation). As such, the image may be represented by a three-dimensional (3D) data structure representing a height, width, and the channels. Similarly, the timing table embedding generator 206 may concatenate the tables to generate a single timing table data structure that may represent all of the timing tables for a particular gate (e.g., for the gate 124). For example, the single data structure (e.g., timing table data structure) may include a height and width, and the channels may be associated with each of the timing tables (e.g., a first channel for the rise delay, a second channel for the fall delay, a third channel for the rise transition, and a fourth channel for the fall transition). Then, similar to image processing, the timing table embedding generator 206 may utilize a neural network such as a CNN to process the timing table data structure and generate table embeddings (e.g., table encodings). For instance, the CNN may convolve and flatten the data structure to generate table embeddings from the timing table data structure. The timing table embedding generator 206 may generate table embeddings for each of the gates (e.g., four table embeddings for the four gates 124-130 of the circuit pathway 120), and provide the table embeddings to the LEGO-Size LLM 108.

In other words, in Natural Language Processing (NLP), word embeddings may be critical for successful downstream for SFT tasks. Directly training embeddings from scratch during SFT has been shown to be less effective compared to pre-training with self-supervised learning tasks. This was observed with the LEGO-Size model 104 as well. As such, by pre-training the embeddings with PD-aware self-supervised tasks, the LEGO-Size model 104 demonstrates significantly better generalization on unseen designs than conventional approaches that rely on direct SFT for gate sizing prediction.

For example, self-supervised tasks may be used to pre-train token embeddings and initialize one or more parameters of the LEGO-Size model 104. These tasks include masked token prediction and cell-based arrival time increment prediction. In the first task, certain tokens are randomly masked, such as the drive strength token, which the LEGO-Size model 104 reconstructs by leveraging PD features, including path, cell, and pin attributes, as well as netlist information encoded by the GT model (e.g., the GT embedding generator 208 described below). In the second task, “arrival increment” represents the stage delay (e.g., cell arc+net arc delays). By using a CNN-based model (e.g., the timing table embedding generator 206) to encode timing tables, the LEGO-Size model 104 predicts arrival time changes with a goal to enhance its PD awareness.

In addition, a decision on which gates to resize depends on factors such as the number of violating paths a gate sits on, the gate's fan-out/fan-in structure, and the gate's sensitivity to other endpoints. To capture this information, a graph transformer embedding generator 208 that utilizes a GT (e.g., one or more graph neural networks (GNNs)) may be used. For example, as mentioned above, the initial data structures 102 may include a set of features for the gates from the circuit pathway (e.g., four initial data structures 102 for the four gates 124-130). In addition, the initial data structures 102 may further include sets of features for gates or circuit elements that are not part of the specific circuit pathway (e.g., the additional initial data structures that are described above). For instance, the initial data structures 102 may be associated with a netlist that indicates the connectivity of an electronic circuit. The netlist may include the gates for the circuit pathway, but may further include additional circuit elements. For instance, as mentioned above, one or more of the gates 124-130 may include inputs associated with the circuit pathway 120, but may further include additional inputs from additional circuit elements. The netlist may indicate the additional circuit elements, and each of the additional circuit elements may be associated with an initial data structure 102. The initial data structures for the gates as well as the additional data structures may be provided to the graph transformer embedding generator 208. The graph transformer embedding generator 208 may filter the initial data structures 102 such that only circuit elements that are within a hop threshold (e.g., less than three hops) are used. For instance, the hop threshold may indicate three hops, which may indicate that the initial data structures 102 associated with three circuit elements (e.g., gates) away from the circuit pathway are to be filtered out. As such, only the initial data structures 102 associated with the gates 124-130 from the circuit pathway 120 and the initial data structures 102 that are within the hop threshold (e.g., three hops) are utilized by the graph transformer embedding generator 208.

The graph transformer embedding generator 208 may then process the filtered initial data structures 102 (e.g., the initial data structures 102 associated with the gates from the circuit pathway and the initial data structures 102 that are within the hop threshold) using the one or more GTs to generate GT node embeddings. For instance, the GTs may be a GT model that includes linear-attention layers and/or GNNs. For example, each cell in a netlist may become a node in the GNN's input graph, and thus, cell-to-cell connections may become edges of the input graph. As such, embodiments of the present disclosure may leverage a specific type of GNN (e.g., a GT) to transform the initial cell features to high-dimensional representations. But, since a GT (e.g., a transformer-based model) is used, embodiments of the present disclosure may need to provide relative orderings of the nodes. To achieve this, embodiments of the present disclosure leverage a node positional encoding technique to generate a positional encoding vector per node of the input graph. Thus, given the netlist node features and the positional encodings, a GT model (e.g., an 8-layer GT model) may first be used to obtain a new high-dimensional embedding per node. Then, a graph-based SFT may be developed to help improve the quality of the GT-generated node embeddings. These embeddings may also be taken as inputs to the LEGO-Size LLM 108 for the path-based SFT tasks, including the final gate size prediction and/or slack improvement prediction.

In other words, while the LEGO-Size model 104 follows the path-by-path timing optimization methods, it was recognized that graph-based netlist attributes are vital for optimization. The decision on which cells to resize depends on factors such as the number of violating paths a cell sits on, the fan-out/fan-in structure, and its sensitivity to other endpoints. To capture this information, the LEGO-Size model 104 (e.g., the GT embedding generator 208) employs GNNs. Prior GNN approaches in PD limit their scope to local neighborhoods, and may use a 3-hop proxy for instance size changes. Similarly, other conventional approaches propagate information level-by-level, but fail to capture long-range dependencies, akin to limitations in Recurrent Neural Networks (RNNs). Hence, the LEGO-Size model 104 utilizes a scalable GNN that jointly considers all cells.

For instance, the GT embedding generator 208 may perform attention across all nodes simultaneously. Traditional self-attention mechanisms may have O(n²) complexity as

$$Self - Attention ( Q , K , V ) = softmax ( \frac{{QK}^{T}}{\sqrt{{d}_{k}}} ) V$$

where Q, K, V∈ [symbol] ^{n×d}^{ₖ} are the query, key, and value matrices, and dk is the hidden dimension. The quadratic complexity results from the softmax kernel, which computes the dot product of every query with every key, prohibiting practical use for large designs.

To overcome this challenge, embodiments of the present disclosure utilize a linear-complexity attention, which approximates softmax with a kernel feature map φ(·) based on random Fourier features. This is shown as:

$$Linear - Attention ( Q , K , V ) = ϕ ( Q ) ( {ϕ ( K )}^{T} V )$$

$$ϕ ( x ) = {\frac{1}{\sqrt{m}} [ exp ( i {ω}_{1}^{T} x ) , … , exp ( i {ω}_{m}^{T} x ) ]}^{T} ,$$

with ω₁, . . . , ωₘ sampled from a normal distribution [symbol] (0, I). This reduces complexity to O(n), allowing efficient computation of node embeddings. To further improve computational efficiency, instead of feeding the entire netlist into the GT embedding generator 208, embodiments of the present disclosure focus on relevant cells, including those on PBA-violating paths (e.g., target cells such as the gates 142-148 of FIG. 1C), within a 3-hop neighborhood (e.g., support cells such as gates 150-158 of FIG. 1C), or the remaining cells (e.g., gates 160 and 162 of FIG. 1C). This reduces unnecessary computation, as the majority of cells have positive slack and minimal impact on sizing.

To encode graph Positional Embeddings (PE) into the GT embedding generator 208, a Random Walk PE (RWPE) may be used, where the random walk operator is RW=AD⁻¹. The k-step random walk RW^{k} defines a node's PE as

$$RWPE ( i ) = [ {RW}_{ii} , {RW}_{ii}^{2} , … , {RW}_{ii}^{k} ]$$

with k=12 in some embodiments. These PE vectors are computed once per node and used throughout the learning process.

The GT embedding generator 208 may build node embeddings using a transformation method, where each node represents a cell, and each edge represents a timing arc, with skip connections added between start-points and end-points. The initial node features include physical, timing, and RC attributes, and arc delays are used as edge features. The aggregation process at each layer l is summarized as:

$${X}_{MP}^{( l + 1 )} , {E}^{( l + 1 )} = GINE ( {X}^{( l )} , {E}^{( l )} , A ) ,$$

$${X}_{LA}^{( l + 1 )} = Linear - Attention ( {X}^{( l )} ) ,$$

$${X}^{( l + 1 )} = MLP ( {X}_{MP}^{( l + 1 )} + {X}_{LA}^{( l + 1 )} ) ,$$

where GINE is a message passing network, A is the adjacency matrix, and X^{(l)}, E^{(l)} are the node and edge features at layer l. At each level, node and edge embeddings from the previous level are processed through the GINE module for local aggregation, and the linear attention layer for global netlist encoding. The outputs of these two modules are then merged and passed through a Multi-Layer Perceptron (MLP) to generate the next-level embeddings X^{(l+1)}. Ultimately, the embeddings X^{(L)} from the last layer L are fed to the LEGO-Size LLM 108 for gate size predictions. During SFT, a graph-based size prediction task may be introduced to further improve the quality of node embeddings, making it more task-relevant.

The LEGO-Size LLM 108 may receive the embeddings from the generators 204-208.

For instance, the LEGO-Size LLM 108 may receive the LibCell name embeddings, the table embeddings, and the GT node embeddings. The LEGO-Size LLM 108 may concatenate the three embeddings for each gate to generate a concatenated input LLM embedding. The LEGO-Size LLM 108 may process the concatenated input LLM embedding using an LLM to generate an LLM output. For instance, the LEGO-Size LLM 108 may project the concatenated input LLM embedding to generate embedding projections and concatenate the embedding projections with positional encoding information. Then, the LEGO-Size LLM 108 may process the concatenated embedding projections and the positional encoding information with an attention block to generate an LLM output.

For example, the LEGO-Size LLM 108 may include one or more attention blocks, which may be an attention mechanism of an LLM encoder of the LEGO-Size LLM 108. In some embodiments, the LEGO-Size LLM 108 may include an N number (e.g., twelve) of attention blocks that stack on top of one another, with the very first block taking raw inputs formed by the token embedding, the table embedding, and the node embedding (e.g., the embeddings from the generators 204-208). The LEGO-Size LLM 108 may further include a trainable projection layer that is configured to map these concatenated inputs to higher-dimensions. The output of the projection layer may be concatenated with the positional encodings of each token (e.g., the positional encoding information), which may be obtained by one or more techniques such as a Rotary Positional Encoding technique. The goal of the positional encoding may be to assign a “position vector” to each token along a path. In some instances, in a high-level, sinusoidal waves may be leveraged for the assignment. With these inputs of each token along a path (e.g., the projected embedding and the positional encoding), the N-layer attention blocks (e.g., the twelve layer attention blocks) may be leveraged to obtain the final high-dimensional embeddings of each token, and these embeddings are then used in downstream self-supervised and SFT tasks.

In some instances, the output data 110 may be the vectors that are generated by the LEGO-Size LLM 108. In other instances, the LLM output may be one or more vectors. For example, for each gate, the LEGO-Size LLM 108 may generate three vectors—a first vector for the type of gate, a second vector for the drive strength, and a third vector for the VT. The LEGO-Size LLM 108 and/or another entity may convert the three vectors into strings and output the strings as the output data 110. For example, for the circuit pathway 120, the LEGO-Size LLM 108 may generate four strings for each of the four gates, and each string may include three elements that are based on the three vectors that are generated by the LEGO-Size LLM 108.

In some examples, the LEGO-Size model 104 may further utilize the library cell search 202 to retrieve a specific LibCell associated with the strings determined by the LEGO-Size LLM 108. For example, as mentioned previously, each LibCell within the LibCell library may be associated with a particular type of gate, drive strength, and VT. Using the strings that indicate the type of gate, drive strength, and VT, the LEGO-Size model 104 may retrieve a specific LibCell from the LibCell library associated with the strings. For instance, for the circuit pathway 120, the LEGO-Size model 104 may retrieve four LibCells associated with the four strings for the four gates 124-130. The LEGO-Size model 104 may output the four retrieved LibCells as the output data 110.

In some variations, the LEGO-Size model 104 may be trained in two stages—a pre-training stage and a fine-tuning stage. For example, the components and functionality of the LEGO-Size model 104 is described above. During the pre-training stage, the LEGO-Size model 104 may be trained utilizing a masking of one or more elements from the strings associated with the gates. For instance, as mentioned above, each gate may be associated with a string comprising three elements—a type of the gate, a drive strength, and a VT. During the pre-training stage, one or more of the elements from one or more strings (e.g., one element from one string) may be masked. For example, referring to the circuit pathway 120, the drive strength for the second gate 126 may be masked (e.g., a masked token for the drive strength for the second gate 126 may be input into the embedding generators 106 such as the token and function embedding generator 204). The LEGO-Size model 104 may process the masked token along with the other elements from the same string (e.g., the type of gate and the VT for the second gate 126) as well as the other strings for the circuit pathway (e.g., the strings for the first, third, and fourth gates 124, 128, and 130 that are not masked) to generate one or more outputs.

For instance, the outputs may indicate a classifier for the masked element (e.g., a masked token prediction). For example, as mentioned above, the LEGO-Size model 104 may generate three vectors for each gate that may be converted into a string for the gate. As such, based on masking the drive strength for the second gate 126, the LEGO-Size model 104 may generate three vectors for the second gate 126, and one of the vectors may be a prediction for the drive strength for the second gate 126. A masked token prediction loss may be computed based on comparing the predicted masked token (e.g., the prediction for the drive strength for the second gate 126) with the actual masked element (e.g., the actual drive strength for the second gate 126 that was masked).

In addition to the masked token prediction loss, during the pre-training phase, an additional loss (e.g., the arrival loss) may further be computed. For example, the LEGO-Size model 104 may further determine an arrival time prediction for the circuit pathway (e.g., the circuit pathway 120). For instance, an arrival time may be a time associated with a signal to reach a specific point, and thus an arrival time for the circuit pathway may be a time for the signal to reach an end point from a start point. In other words, each of the gates 124-130 may be associated with a delay time (e.g., a time for a signal to propagate within the gate). An arrival time for the circuit pathway 120 may be a time for a signal to propagate from the start point 122 to the end point 132, and this time may be based on the delay times for each of the gates 124-130. The LEGO-Size model 104 may generate an arrival time prediction by performing regression-based learning. For instance, this may occur in the self-supervised phase, where given a timing path, the label of each arrival time at the output pin of each cell along the path may be obtained. Furthermore, this arrival time prediction task may be purposefully developed to let the LEGO-Size model 104 predict these known arrival times, which allows the LEGO-Size model 104 to have the understanding of the timing propagation.

Furthermore, using the initial data structures 102 and/or other information, an actual arrival time for the circuit pathway (e.g., the circuit pathway 120) may be determined. The arrival loss may be based on comparing the actual arrival time for the circuit pathway with the arrival time prediction. Subsequently, the LEGO-Size model 104 may be trained during the pre-training phase using the two losses—the arrival loss and the masked token prediction loss. For instance, the parameters and/or weights of the LEGO-Size model 104 (e.g., the embedding generators 106 and the Lego-Size LLM 108) may be updated based on the arrival loss and the masked token prediction loss. For example, using the two losses, the token embeddings within the trainable library embeddings tables (e.g., the trainable library token embedding table and the trainable function embedding table) may be updated. In addition, using the two losses, the CNN from the timing table embedding generator 206, the GT from the graph transformer embedding generator 208 and the LLM from the LEGO-Size LLM 108 may be trained.

After completing the pre-training stage, the LEGO-Size model 104 may further be trained using the fine-tuning stage. For the fine-tuning stage, a masked token is not used, and instead, a ground-truth circuit pathway is used to determine the losses of the LEGO-Size model 104. For example, based on the initial data structures 102 and the circuit pathway (e.g., the circuit pathway 120), the LEGO-Size may output strings for each gate of the circuit pathway (e.g., the four strings from the gates 124-130 of the circuit pathway 120). Afterwards, a ground-truth circuit pathway may be obtained. The ground-truth circuit pathway may be obtained using a tool such as the SYNOPSYS PRIMETIME tool (e.g., an optimization tool and/or model), and may indicate ground-truth LibCells for the circuit pathway (e.g., the optimized LibCells). Based on comparing the ground-truth circuit pathway and the predicted circuit pathway (e.g., the predicted Libcells indicated by the strings of the LEGO-Size model 104), an actual classifier loss may be determined.

Furthermore, during the fine-tuning stage, an additional loss (e.g., the slack loss) may further be computed. For example, the LEGO-Size model 104 may further output a slack time prediction for the circuit pathway (e.g., the circuit pathway 120). For instance, a slack time may be a difference between a time required for a signal to travel through a circuit path and a time available for the signal to reach its destination. For instance, the circuit pathway 120 may indicate a time required for a signal to travel through the circuit (e.g., the gates 124-130) without a setup violation that causes incorrect data to be captured and a time available for the signal to propagate from the start point 122 to the end point 132. The LEGO-Size model 104 may further generate a prediction slack time based on using a regressor head as an arrival time prediction. For instance, the “regression” may indicate a prediction of continuous values as opposed to a “classification.” In the slack prediction task, the LEGO-Size model 104 may obtain a groundtruth optimization label from a commercial tool, which indicates how much slack has improved on each path. Hence, during the SFT phase, one of the tasks of the LEGO-Size model 104 may be to predict this slack improvement. In other words, the LEGO-Size model 104 may be trained to predict how much slack value of each path would the commercial tool improve.

Following, an actual slack time may be determined based on the circuit pathway 120 and the initial data structures 102, and a slack loss may be computed based on the actual slack time and the predicted slack time. Afterwards, similar to the pre-training stage, during the fine-tuning stage and using the two losses (e.g., the slack loss and the actual classifier loss), the components of the LEGO-Size model 104 may be trained. For instance, the token embeddings within the trainable library embeddings tables may be fine-tuned and the CNN from the timing table embedding generator 206, the GT from the graph transformer embedding generator 208 and the LLM from the LEGO-Size LLM 108 may be further fine-tuned.

In other words, after pre-training the token and function embedding generator 204, the LEGO-Size model 104 may be fine-tuned using SFT tasks, including path-based slack improvement and optimized gate size prediction, with groundtruth labels from a commercial signoff tool. Unlike conventional approaches, which predicts gate sizes sequentially, the LEGO-Size model 104 predicts all gate sizes on a path simultaneously. First, embodiments of the present disclosure may tokenize the PBA-violating path into a sequence of library and extract timing table embeddings via CNN. Concurrently, the GT embedding generator 208 aggregates node features. The generated embeddings are concatenated with the token and table embeddings as inputs to the LEGO-Size LLM 108. Rotary PE may be applied to preserve the order of library tokens, with the self-attention mechanism operating across N=12 layers.

In some embodiments, the idea of slack improvement conditioning may be to train the LEGO-Size model 104 to learn the precise amount of gate size change required to achieve the target slack improvement (e.g., the condition), which enables flexible trade-offs between timing and power. During SFT, the conditioning may be achieved through teacher forcing, where the groundtruth slack improvement value is used as input. However, at inference, the LEGO-Size model 104 uses predicted slack improvement values to predict gate sizes. Another aspect of embodiments of the present disclosure may be to incorporate an entropy term as a regularization loss alongside the standard CrossEntropy (CE) loss for gate size prediction. Given a probability vector P=[p₁, p₂, . . . , pₙ], the entropy function may be

$$H ( P ) = - {\sum }_{i = 1}^{n} {p}_{i} log ( {p}_{i} ) .$$

This entropy regularization may help prevent overconfidence in the LEGO-Size model's 104 predictions by avoiding cases where a single gate size dominates with an excessively high probability, ensuring better generalization. In addition, the SFT loss functions for both slack improvement and gate size predictions are defined as follows:

$${ℒ}_{size} = CE ( {\hat{Y}}_{size} , {Y}_{size} ) + λ \cdot H ( {\hat{Y}}_{size} ) ,$$

$${ℒ}_{slack} = RMSE ( {\hat{Y}}_{slack} , {Y}_{slack} ) ,$$

where {Ŷ} denote the predictions, {Y} denote the groundtruths, λ denotes the regularization coefficient, and RMSE denotes the root-mean-squared-error loss. In some embodiments, the regularization coefficient λ may be set at 0.001.

As such, in summary, embodiments of the present disclosure describe processing input strings associated with gates of a circuit pathway (e.g., circuit pathway 120 of FIG. 1B) using a LEGO-Size model 104 to generate output strings for the gates of the circuit pathway. The output strings may indicate optimized Library Cells (LibCells) for the gates of the circuit pathway. In some instances, the output strings for all of the gates of the circuit pathway are generated in one iteration of using the LEGO-Size model 104 and not in multiple iterations. The output strings may directly map to a LibCell from a LibCell library whereas in contrast, conventional approaches utilize bins and then a search (e.g., if a buffer has 1000 different LibCells, then conventional approaches would first place the 1000 different LibCells into bins and then perform a heuristic search within a bin to determine the LibCell). Additionally, and/or alternatively, embodiments of the present disclosure describe training of the LEGO-Size model 104 using a pre-training stage and a fine-tuning stage. The pre-training stage trains the LEGO-Size model 104 using a masked token prediction loss and arrival loss, and the fine-tuning stage trains the LEGO-Size model 104 using a slack loss and an actual classifier loss. Additionally, and/or alternatively, embodiments of the present disclosure describe the LEGO-Size model 104 that includes embedding generators 106 (e.g., a token and function embedding generator 204, a timing table embedding generator 206, and a graph transformer embedding generator 208) that generates embeddings for each gate. The embeddings are concatenated and processed by an LEGO-Size LLM to generate output data 110.

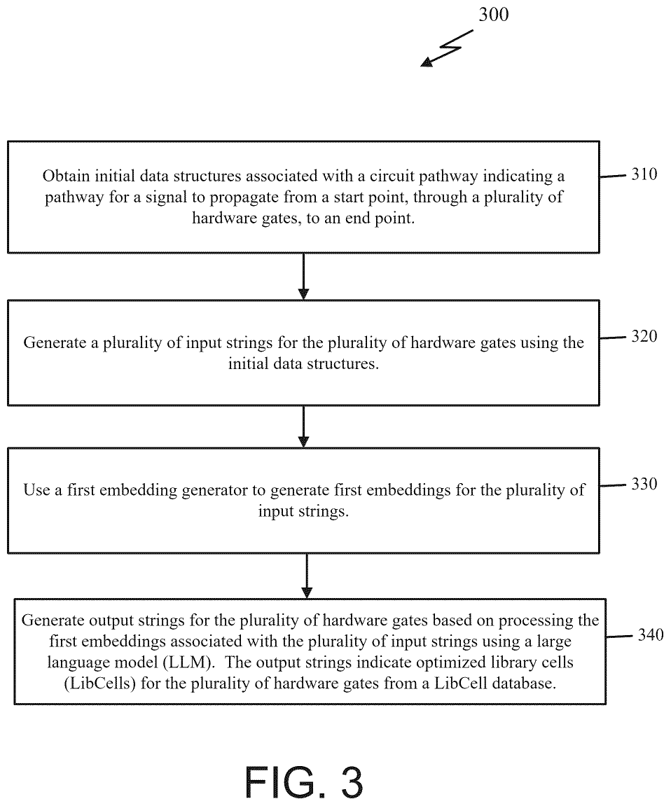

FIG. 3 provides a flow diagram illustrating a method 300 for performing VLSI gate sizing for PPA optimization using the LEGO-Size model 104, in accordance with an embodiment. Each block of method 300, described herein, comprises a computing process that may be performed using any combination of hardware, firmware, and/or software. For instance, various functions may be carried out by a processor executing instructions stored in memory. The method 300 may be executed by any one system, or any combination of systems, including, but not limited to, those described herein. Furthermore, persons of ordinary skill in the art will understand that any system that is capable of performing method 300 is within the scope and spirit of embodiments of the present disclosure.

At step 310, the method 300 includes obtaining initial data structures 102 associated with a circuit pathway (e.g., circuit pathway 120) indicating a pathway for a signal to propagate from a start point (e.g., start point 122), through a plurality of hardware gates (e.g., gates 124-130), to an end point (e.g., end point 132). In an embodiment, the plurality of hardware gates comprise a plurality of logic gates, and each of the plurality of logic gates is associated with an initial data structure from the initial data structures 102. The initial data structures 102 indicate physical features and netlist features for the plurality of logic gates.

At step 320, the method 300 includes generating a plurality of input strings for the plurality of hardware gates using the initial data structures 102. In an embodiment, generating the plurality of input strings comprises searching the LibCell database that stores a plurality of Libcells to obtain a LibCell for each of the plurality of hardware gates based on the initial data structures, determining a type, a driving strength, and a threshold voltage (VT) for each of the plurality of hardware gates based on the obtained LibCells for the plurality of hardware gates, and generating an input string for each gate from the plurality of hardware gates based on the type of the gate, the driving strength of the gate, and the VT of the gate. Each of the plurality of input strings comprises a first element for the type of the gate, a second element for the driving strength of the gate, and a third element for the VT of the gate.

At step 330, the method 300 includes using a first embedding generator (e.g., the token and function embedding generator 204) to generate first embeddings for the plurality of input strings. In an embodiment, using the first embedding generator to generate the first embeddings for the plurality of input strings comprises using a library token embedding table to generate three tokens for each input string from the plurality of input strings and generating the first embeddings based on the three tokens. The three tokens comprise a first token for the type of the gate, a second token for the driving strength of the gate, and a third token for the VT of the gate. In an embodiment, using the first embedding generator to generate the first embeddings for the plurality of input strings further comprises using a function embedding table to generate a plurality of function embeddings and concatenating the three tokens with a function embedding, from the plurality of function embeddings, to generate a plurality of LibCell name embeddings. Each of the plurality of LibCell name embeddings is associated with a gate from the plurality of hardware gates.

At step 340, the method 300 includes generating output strings for the plurality of hardware gates based on processing the first embeddings associated with the plurality of input strings using an LLM (e.g., the LEGO-Size LLM 108). The output strings indicate optimized library cells (LibCells) for the plurality of hardware gates from a LibCell database.

In an embodiment, the method 300 further includes based on the initial data structures, searching the LibCell database that stores a plurality of Libcells to obtain a LibCell for each of the plurality of hardware gates, based on the obtained LibCells for the plurality of hardware gates, determining a plurality of timing tables for each of the plurality of hardware gates, and using a second embedding generator (e.g., the timing table embedding generator 206) to generate second embeddings for the plurality of hardware gates. Further, generating the output strings for the plurality of hardware gates comprises processing the first embeddings associated with the plurality of input strings and the second embeddings using the LEGO-Size LLM 108 to generate the output strings.

In an embodiment, using the second embedding generator to generate the second embeddings for the plurality of hardware gates comprises concatenating the plurality of timing tables for each of the plurality of hardware gates to generate a plurality of three-dimensional (3D) timing table data structures and processing the 3D timing table data structures using a convolutional neural network (CNN) to generate the second embeddings.

In an embodiment, the circuit pathway is part of an electronic circuit and the initial data structures 102 indicate features for a plurality of hardware components from a netlist for the electronic circuit. The method 300 further includes processing the initial data structures 102 using a graph transformer (GT) (e.g., the GT embedding generator 208) to generate GT node embeddings for the plurality of hardware gates. Further, generating the output strings for the plurality of hardware gates comprises processing the first embeddings associated with the plurality of input strings, second embeddings associated with timing tables of the plurality of hardware gates and the GT node embeddings for the plurality of hardware gates to generate the output strings for the plurality of hardware gates.

In an embodiment, processing the initial data structures 102 using the GT comprises filtering the initial data structures 102 based on a hop threshold to obtain filtered initial data structures and processing the filtered initial data structures using the GT to generate the GT node embeddings for the plurality of hardware gates. In an embodiment, the output strings for the plurality of hardware gates indicate types, driving strengths, and threshold voltages (VTs) for the plurality of hardware gates. The method 300 further includes searching the LibCell database using the output strings to determine the optimized LibCells for the plurality of hardware gates and outputting the optimized LibCells for the plurality of hardware gates.

In an embodiment, a LEGO-Size model 104 comprises the first embedding generator and the LEGO-Size LLM 108. The LEGO-Size model 104 may be trained by performing pre-training of the LEGO-Size model 104 using a masked token prediction loss and an arrival loss and performing fine-tuning of the LEGO model using a slack loss and an actual classifier loss. In an embodiment, performing the pre-training of the LEGO-Size model 104 comprises: generating a plurality of training input strings for a plurality of training hardware gates, wherein each of the plurality of training input strings comprises a first element, a second element, and a third element; masking one or more tokens associated with one or more elements from the plurality of training input strings; generating training output strings using the LEGO model based on masking the one or more tokens; and computing the masked token prediction loss based on the training output strings and the one or more elements from the plurality of training input strings that were masked.

In an embodiment, performing fine-tuning of the LEGO model comprises: generating training output strings using the LEGO model based on training initial data structures associated with training hardware gates for a training circuit pathway; obtaining ground-truth output strings for the training hardware gates for the training circuit pathway; and computing the actual classifier loss based on comparing the training output strings and the ground-truth output strings.

In an embodiment, at least one of steps 310-340 are performed on a server or in a data center to generate the output strings for the plurality of hardware gates, and the output strings are streamed and/or provided to a user device. In an embodiment, at least one of steps 310-340 is performed within a cloud computing environment. In an embodiment, at least one of steps 310-340 is performed for training, testing, or certifying a neural network employed in a machine, robot, or autonomous vehicle. In an embodiment, at least one of steps 310-340 is performed on a virtual machine comprising a portion of a graphics processing unit.

In some examples, in contrast to conventional systems, embodiments of the present disclosure utilize a LEGO-Size model 104 that leverages LLMs and GPU-accelerated differentiable approaches for gate sizing prediction and/or optimization. By utilizing the LEGO-Size model 104, embodiments of the present disclosure may provide a scalable, generalizable framework that is capable of delivering instant, better-than-tool signoff timing optimization results on unseen designs in advanced nodes. For instance, embodiments of the present disclosure describe a generative framework that harnesses the power of LLMs and GPU-accelerated differentiable techniques to achieve better-than-tool gate sizing results in signoff-quality. The LEGO-Size model 104 introduces multiple aspects. For instance, the LEGO-Size model 104 considers timing paths as sequences of tokenized library cells (e.g., strings), which casts the gate sizing prediction task as a language modeling problem and solves the problem through customized self-supervised learning and Supervised FineTuning (SFT) approaches. The LEGO-Size model 104 develops a GT (e.g., the GT embedding generator 208) with a linear-complexity attention mechanism for netlist encoding, which enables the LEGO-Size LLM 108 to make sizing decisions with a global perspective.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

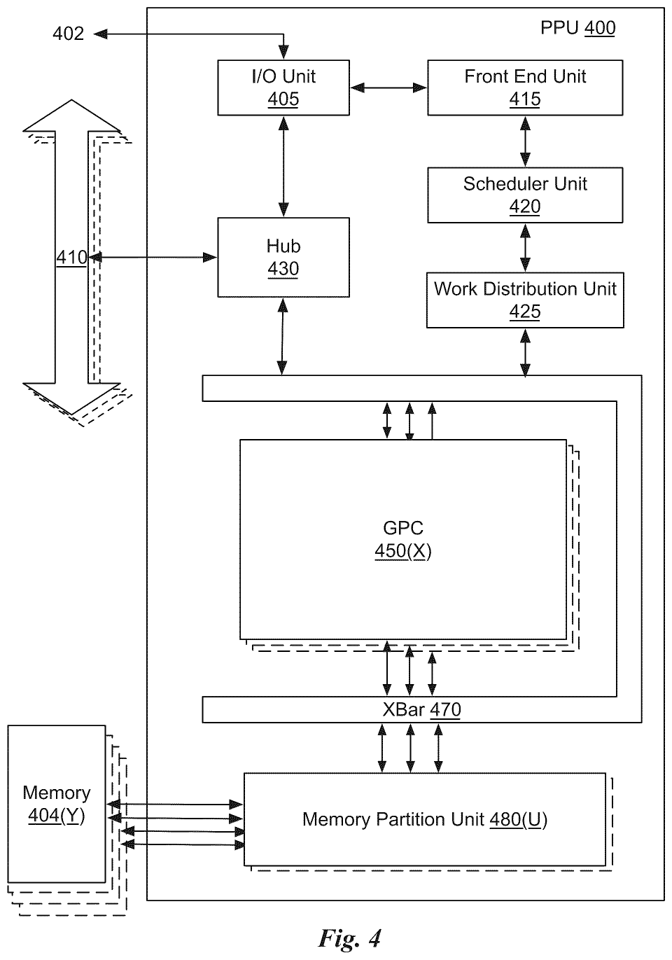

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

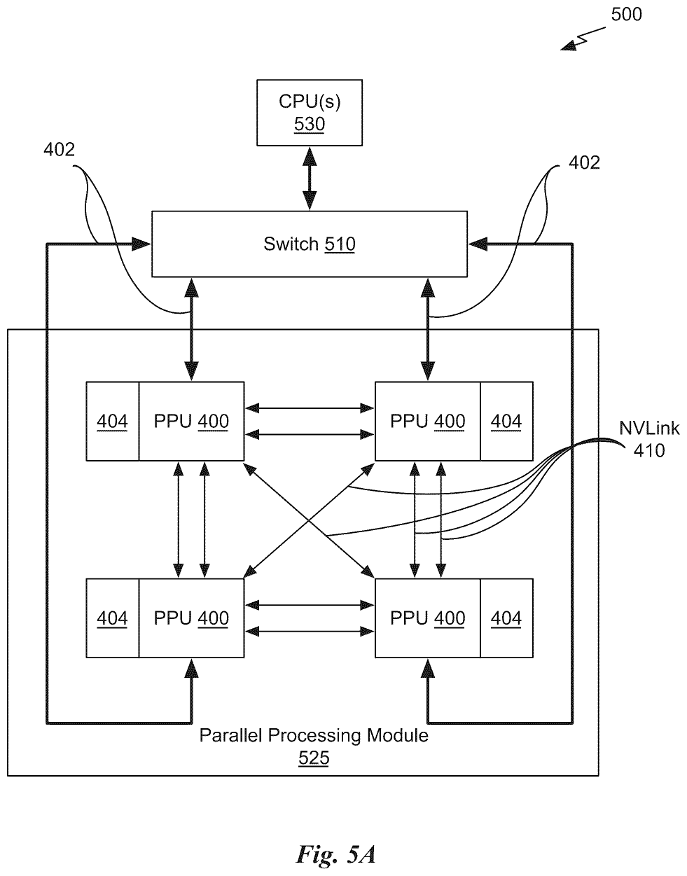

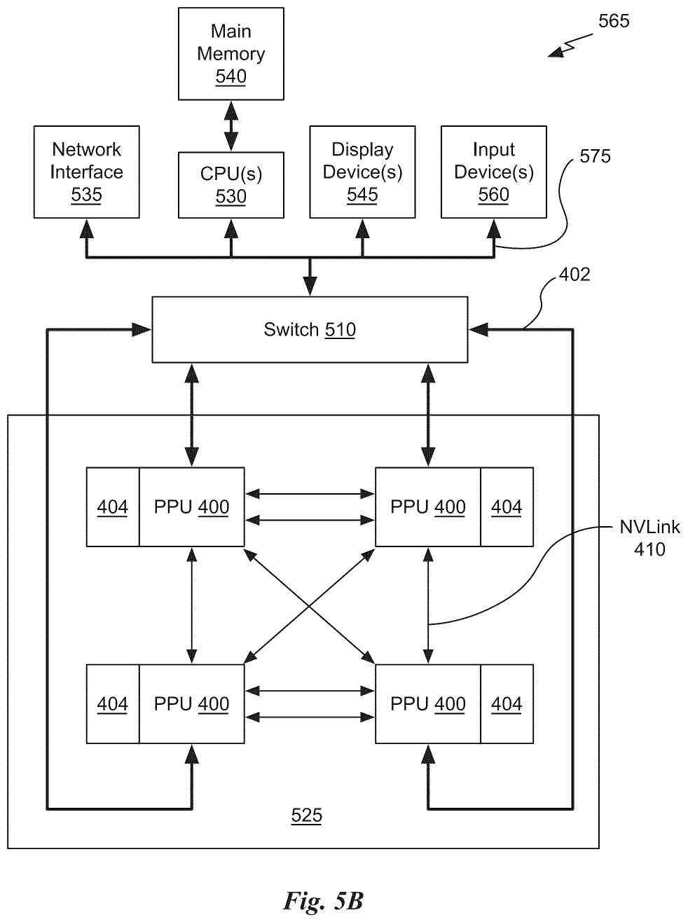

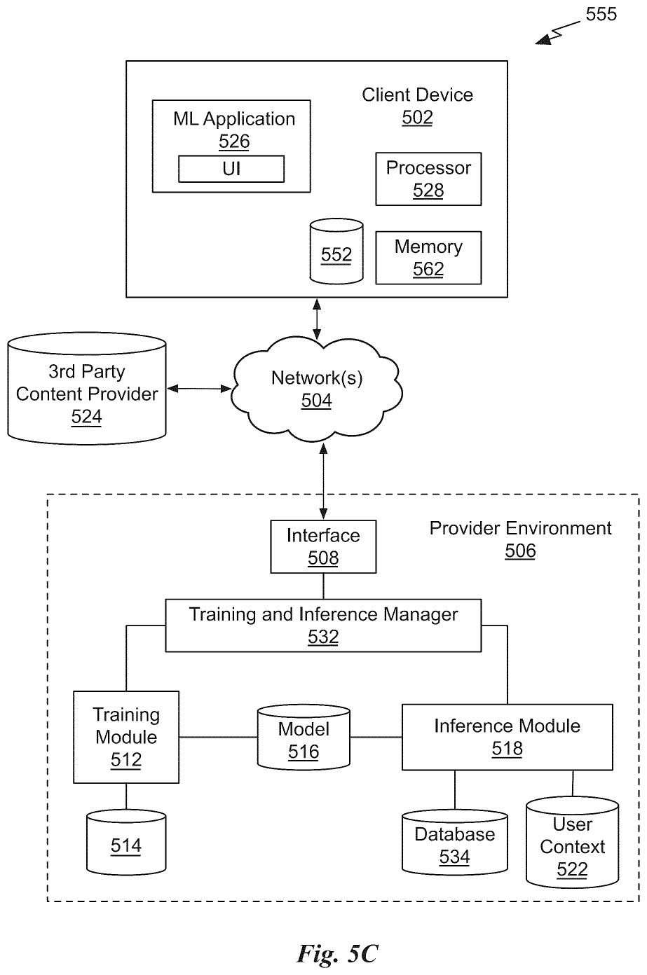

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

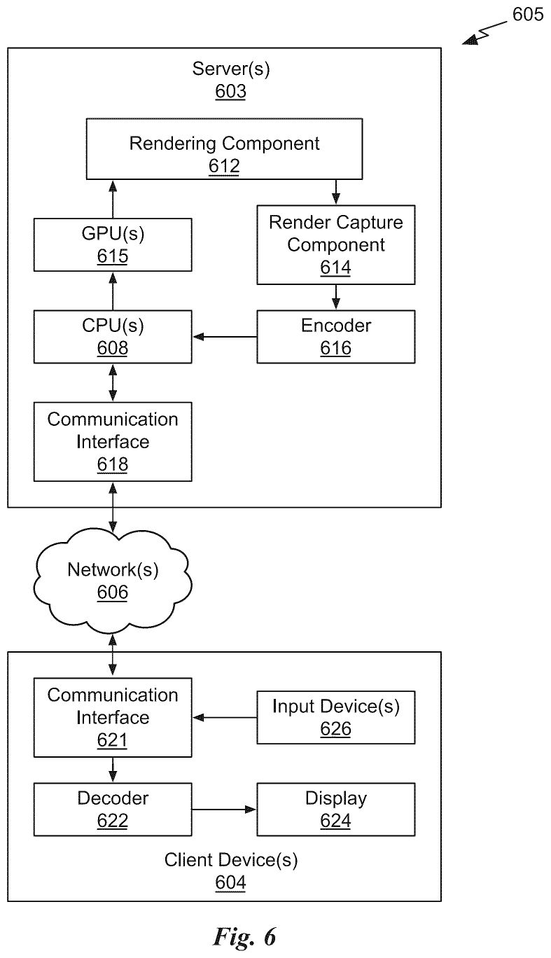

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for performing very large scale integration (VLSI) gate sizing for power, performance, and area (PPA) optimization, comprising:
obtaining initial data structures associated with a circuit pathway indicating a pathway for a signal to propagate from a start point, through a plurality of hardware gates, to an end point;
generating a plurality of input strings for the plurality of hardware gates using the initial data structures;
using a first embedding generator to generate first embeddings for the plurality of input strings; and
generating output strings for the plurality of hardware gates based on processing the first embeddings associated with the plurality of input strings using a large language model (LLM), wherein the output strings indicate optimized library cells (LibCells) for the plurality of hardware gates from a LibCell database.

2. The computer-implemented method of claim 1, wherein the plurality of hardware gates comprise a plurality of logic gates, and wherein each of the plurality of logic gates is associated with an initial data structure from the initial data structures, wherein the initial data structures indicate physical features and netlist features for the plurality of logic gates.

3. The computer-implemented method of claim 1, wherein generating the plurality of input strings for the plurality of hardware gates using the initial data structures comprises:
based on the initial data structures, searching the LibCell database that stores a plurality of Libcells to obtain a LibCell for each of the plurality of hardware gates;
based on the obtained LibCells for the plurality of hardware gates, determining a type, a driving strength, and a threshold voltage (VT) for each of the plurality of hardware gates; and
generating an input string for each gate from the plurality of hardware gates based on the type of the gate, the driving strength of the gate, and the VT of the gate, wherein each of the plurality of input strings comprises a first element for the type of the gate, a second element for the driving strength of the gate, and a third element for the VT of the gate.

4. The computer-implemented method of claim 3, wherein using the first embedding generator to generate the first embeddings for the plurality of input strings comprises:
using a library token embedding table to generate three tokens for each input string from the plurality of input strings, wherein the three tokens comprise a first token for the type of the gate, a second token for the driving strength of the gate, and a third token for the VT of the gate; and
generating the first embeddings based on the three tokens.

5. The computer-implemented method of claim 4, wherein using the first embedding generator to generate the first embeddings for the plurality of input strings further comprises:
using a function embedding table to generate a plurality of function embeddings; and
concatenating the three tokens with a function embedding, from the plurality of function embeddings, to generate a plurality of LibCell name embeddings, wherein each of the plurality of LibCell name embeddings is associated with a gate from the plurality of hardware gates.

6. The computer-implemented method of claim 1, further comprising:
based on the initial data structures, searching the LibCell database that stores a plurality of Libcells to obtain a LibCell for each of the plurality of hardware gates;
based on the obtained LibCells for the plurality of hardware gates, determining a plurality of timing tables for each of the plurality of hardware gates; and
using a second embedding generator to generate second embeddings for the plurality of hardware gates,
wherein generating the output strings for the plurality of hardware gates comprises:
processing the first embeddings associated with the plurality of input strings and the second embeddings using the LLM to generate the output strings.

7. The computer-implemented method of claim 6, wherein using the second embedding generator to generate the second embeddings for the plurality of hardware gates comprises:
concatenating the plurality of timing tables for each of the plurality of hardware gates to generate a plurality of three-dimensional (3D) timing table data structures; and
processing the 3D timing table data structures using a convolutional neural network (CNN) to generate the second embeddings.

8. The computer-implemented method of claim 1, wherein the circuit pathway is part of an electronic circuit and the initial data structures indicate features for a plurality of hardware components from a netlist for the electronic circuit, and wherein the method further comprises:
processing the initial data structures using a graph transformer (GT) to generate GT node embeddings for the plurality of hardware gates, and
wherein generating the output strings for the plurality of hardware gates comprises:
processing the first embeddings associated with the plurality of input strings, second embeddings associated with timing tables of the plurality of hardware gates, and the GT node embeddings for the plurality of hardware gates to generate the output strings for the plurality of hardware gates.

9. The computer-implemented method of claim 8, wherein processing the initial data structures using the GT comprises:
filtering the initial data structures based on a hop threshold to obtain filtered initial data structures; and
processing the filtered initial data structures using the GT to generate the GT node embeddings for the plurality of hardware gates.

10. The computer-implemented method of claim 1, wherein the output strings for the plurality of hardware gates indicate types, driving strengths, and threshold voltages (VTs) for the plurality of hardware gates, and wherein the method further comprises:
searching the LibCell database using the output strings to determine the optimized LibCells for the plurality of hardware gates; and
outputting the optimized LibCells for the plurality of hardware gates.

11. The computer-implemented method of claim 1, wherein an LLM-Enhanced GPU-Optimized (LEGO) model comprises the first embedding generator and the LLM, and wherein training the LEGO model comprises:
performing pre-training of the LEGO model using a masked token prediction loss and an arrival loss; and
performing fine-tuning of the LEGO model using a slack loss and an actual classifier loss.

12. The computer-implemented method of claim 11, wherein performing the pre-training of the LEGO model comprises:
generating a plurality of training input strings for a plurality of training hardware gates, wherein each of the plurality of training input strings comprises a first element, a second element, and a third element;
masking one or more tokens associated with one or more elements from the plurality of training input strings;
generating training output strings using the LEGO model based on masking the one or more tokens; and
computing the masked token prediction loss based on the training output strings and the one or more tokens from the plurality of training input strings that were masked.

13. The computer-implemented method of claim 11, wherein performing fine-tuning of the LEGO model comprises:
generating training output strings using the LEGO model based on training initial data structures associated with training hardware gates for a training circuit pathway;
obtaining ground-truth output strings for the training hardware gates for the training circuit pathway; and
computing the actual classifier loss based on comparing the training output strings and the ground-truth output strings.

14. The computer-implemented method of claim 1, wherein at least one of the steps of obtaining, generating, and using are performed on a server or in a data center to generate the output strings, and the output strings are provided to a user device.

15. The computer-implemented method of claim 1, wherein at least one of the steps of obtaining, generating, and using are performed within a cloud computing environment.

16. The computer-implemented method of claim 1, wherein at least one of the steps of obtaining, generating, and using are performed for training, testing, or certifying a neural network employed in a machine, robot, or autonomous vehicle.

17. The computer-implemented method of claim 1, wherein at least one of the steps of obtaining, generating, and using is performed on a virtual machine comprising a portion of a graphics processing unit.

18. A system for performing very large scale integration (VLSI) gate sizing for power, performance, and area (PPA) optimization, comprising:
one or more processors; and
a non-transitory computer-readable medium having processor-executable instructions stored thereon, wherein the processor-executable instructions, when executed by the one or more processors, facilitate:
obtaining initial data structures associated with a circuit pathway indicating a pathway for a signal to propagate from a start point, through a plurality of hardware gates, to an end point;
generating a plurality of input strings for the plurality of hardware gates using the initial data structures;
using a first embedding generator to generate first embeddings for the plurality of input strings; and
generating output strings for the plurality of hardware gates based on processing the first embeddings associated with the plurality of input strings using a large language model (LLM), wherein the output strings indicate optimized library cells (LibCells) for the plurality of hardware gates from a LibCell database.

19. The system of claim 18, wherein the plurality of hardware gates comprise a plurality of logic gates, and wherein each of the plurality of logic gates is associated with an initial data structure from the initial data structures, wherein the initial data structures indicate physical features and netlist features for the plurality of logic gates.

20. A non-transitory computer-readable medium having processor-executable instructions stored thereon, wherein the processor-executable instructions, when executed, facilitate:
obtaining initial data structures associated with a circuit pathway indicating a pathway for a signal to propagate from a start point, through a plurality of hardware gates, to an end point;
generating a plurality of input strings for the plurality of hardware gates using the initial data structures;
using a first embedding generator to generate first embeddings for the plurality of input strings; and
generating output strings for the plurality of hardware gates based on processing the first embeddings associated with the plurality of input strings using a large language model (LLM), wherein the output strings indicate optimized library cells (LibCells) for the plurality of hardware gates from a LibCell database.

21. The non-transitory computer-readable medium of claim 20, wherein the plurality of hardware gates comprise a plurality of logic gates, and wherein each of the plurality of logic gates is associated with an initial data structure from the initial data structures, wherein the initial data structures indicate physical features and netlist features for the plurality of logic gates.
